(19) United States
(12) Patent Application Publication
(10) Pub. No.: US 2023/0207977 A1
(43) Pub. Date: Jun. 29, 2023

(54) SECONDARY BATTERY

(71) Applicant: Samsung SDI Co., Ltd., Yongin-si (KR)

(72) Inventor: Hyun Soo LEE, Yongin-si, (KR)

(21) Appl. No.: 18/147,440

(22) Filed: Dec. 28, 2022

(30) Foreign Application Priority Data
Dec. 29, 2021 (KR) 10-2021-0191201

(51) Int. Cl. H01M 50/531; H01M 50/516; H01M 50/172

(52) U.S. Cl. CPC H01M 50/531; H01M 50/516; H01M 50/172

(57) ABSTRACT

A secondary battery includes: a case having an accommodating space therein; an electrode assembly in the case and having an uncoated portion at one end thereof; a current collector plate electrically connected to the uncoated portion of the electrode assembly; and a cap assembly sealing the case. A region of the current collector plate welded to the uncoated portion has a smaller thickness than other regions of the current collector plate where the current collector plate contacts the uncoated portion.

### CROSS-REFERENCE TO RELATED APPLICATION

This application claims priority to and the benefit of Korean Patent Application No. 10-2021-0191201, filed on Dec. 29, 2021, in the Korean Intellectual Property Office, the entire content of which is incorporated herein by reference.

### BACKGROUND

### 1. Field

Aspects of embodiments of the present disclosure relate to a secondary battery.

### 2. Description of the Related Art

Different from a primary battery that is not designed to be charged, a secondary battery is designed to be a rechargeable and dischargeable battery. A low-capacity secondary battery including only one single cell or a few cells packaged in the form of a pack may be used for various portable small-sized electronic devices, such as cellular phones or camcorders. A high-capacity secondary battery in which several tens of cells are connected together in a battery pack is widely used as a power source for motor driving, such as those in hybrid electric vehicles.

Secondary batteries are manufactured in various shapes, and representative shapes thereof include a cylindrical shape and a square shape. The secondary battery is configured (or manufactured) by installing an electrode assembly, formed by interposing a separator as an insulator between positive and negative plates, and an electrolyte into a case and installing a cap plate in (or on) the case. The electrode assembly is electrically connected to an electrode terminal by a current collector plate.

### SUMMARY

The volume inside the case varies according to the structure of the current collector plate. Further, secondary batteries having additional capacity within a size (e.g., a predetermined size) are increasingly desired. Embodiments of the present disclosure provide a secondary battery having improved welding quality while maintaining rigidity and heat generating (e.g., high heat) performance of a current collector plate.

According to an embodiment of the present disclosure, a secondary battery includes: a case having an accommodating space therein; an electrode assembly in the case and having an uncoated portion at one end thereof; a current collector plate electrically connected to the uncoated portion of the electrode assembly, a region of the current collector plate welded to the uncoated portion having a smaller thickness than other regions of the current collector plate where the current collector plate contacts the uncoated portion; and a cap assembly sealing the case.

The current collector plate may be welded to the uncoated portion at a plurality of regions arranged adjacent to each other in a longitudinal direction of the uncoated portion, and the regions may extend in a direction perpendicular to the longitudinal direction.

The current collector plate may have a groove in the region welded to the uncoated portion.

The current collector plate may include a first piece in contact with the electrode assembly and a second piece shaped to correspond to the first piece, and the second piece may have a welding hole in the region welded to the uncoated portion.

In the first piece, an area corresponding to the welding hole in the second piece may be configured to be exposed to a welding beam.

The current collector plate may include an electrode connection part welded to the uncoated portion of the electrode assembly and a terminal connection part having one end coupled to the electrode connection part and another end coupled to the cap assembly.

A region of the current collector plate that is welded to the uncoated portion may be further recessed inwardly compared to the electrode connection part that is coupled to the terminal connection part.

An inclination angle may be formed between the region where the electrode connection part is coupled to the terminal connection part and a region where the current collector plate contacts the uncoated portion.

A thickness of the region where the current collector plate is welded to the uncoated portion may be in a range of about 0.3 mm to about 0.5 mm.

A thickness of another region of the current collector plate in contact with the uncoated portion may be in a range of about 0.6 mm to about 0.9 mm.

### BRIEF DESCRIPTION OF DRAWINGS

FIG. 1 is a perspective view of a secondary battery according to an embodiment of the present disclosure.

FIG. 2 is a cross-sectional view taken along the line A-A of FIG. 1.

FIG. 3 is an exploded perspective view of a current collector plate and an electrode assembly in a secondary battery according to an embodiment of the present disclosure.

FIG. 4A is a partial perspective view of a current collector plate and an electrode assembly coupled to each other in a secondary battery according to an embodiment of the present disclosure.

FIG. 4B is an exploded perspective view of the current collector plate shown in FIG. 4A.

FIG. 5 is a perspective view of a current collector plate in a secondary battery according to another embodiment of the present disclosure.

FIG. 6 is a cross-sectional view of a current collector plate and an electrode assembly that are coupled to each other in a secondary battery according to another embodiment of the present disclosure.

FIG. 7 is a partial cross-sectional view of the current collector plate shown in FIG. 6.

### DETAILED DESCRIPTION

Embodiments of the present disclosure will now be described, in detail, with reference to the drawings.

Embodiments of the present disclosure are described herein to more completely explain the aspects and features of the present disclosure to those skilled in the art, and the following embodiments may be modified in various other forms. The present disclosure may, however, be embodied in many different forms and should not be construed as being limited to the embodiments set forth herein. Rather, these embodiments are provided so that this disclosure will be thorough and complete and will convey the aspects and features of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

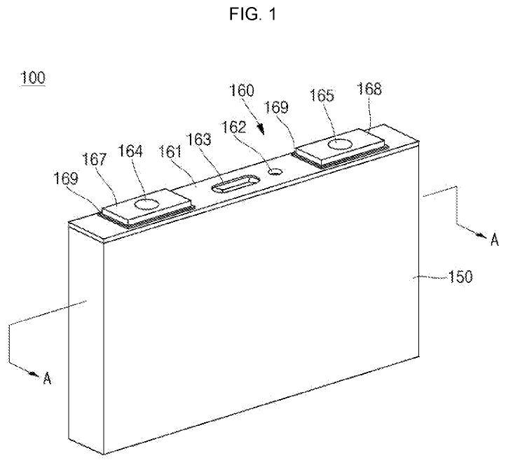

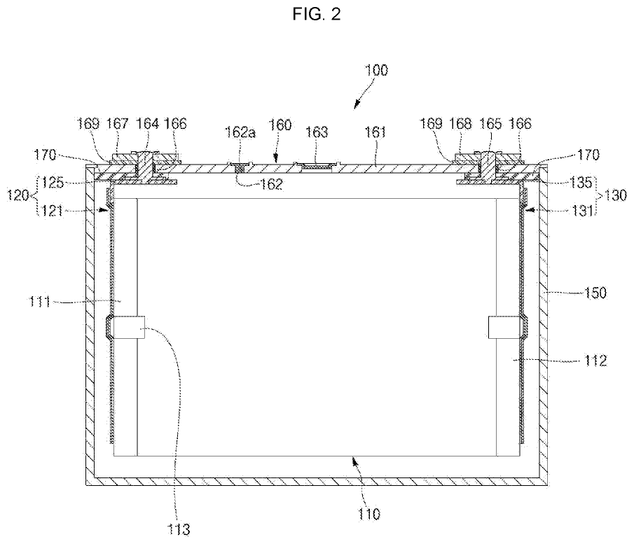

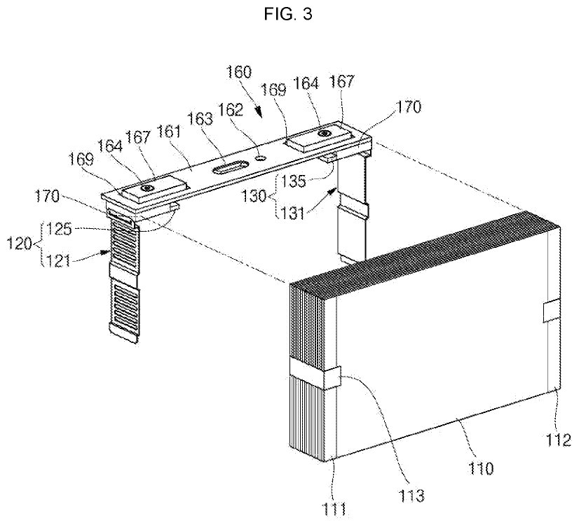

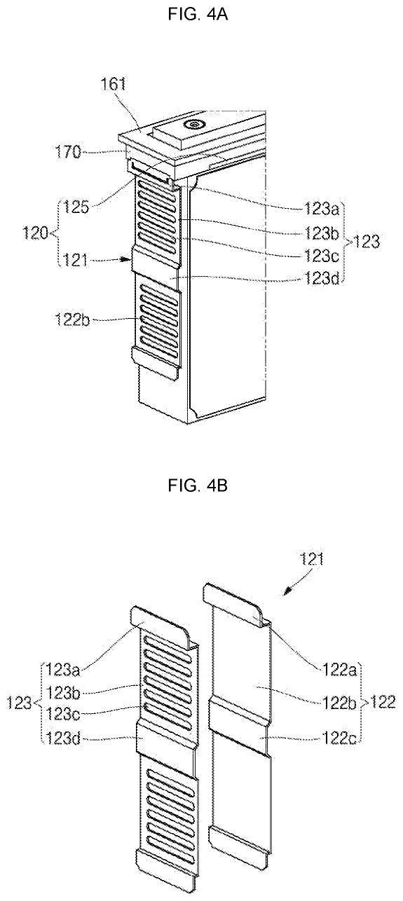

FIG. 1 is a perspective view of a secondary battery according to an embodiment of the present disclosure. FIG. 2 is a cross-sectional view taken along the line A-A of FIG. 1. FIG. 3 is an exploded perspective view of a current collector plate and an electrode assembly in a secondary battery according to an embodiment of the present disclosure. FIG. 4A is a partial perspective view of a current collector plate and an electrode assembly that are coupled to each other in a secondary battery according to an embodiment of the present disclosure, and FIG. 4B is an exploded perspective view of the current collector plate shown in FIG. 4A.

Referring to FIGS. 1 to 4B, a secondary battery 100 according to an embodiment of the present disclosure includes an electrode assembly 110, current collector plates 120 and 130, a case 150, and a cap assembly 160.

The electrode assembly 110 is formed by stacking a plurality of layers of a first electrode plate, a separator, and a second electrode plate, each formed in a thin plate shape or a film shape. In one embodiment, the first electrode plate may act as a first electrode (e.g., a positive electrode), and the second electrode plate may act as a second electrode (e.g., a negative electrode). Of course, in other embodiments, the first electrode plate and the second electrode plate may be arranged to have any polarity as long as the polarities are different from each other.

The first electrode plate is formed by coating a first electrode active material, such as a transition metal oxide, on a first electrode current collector formed of a metal foil, such as aluminum. The first electrode plate has a first electrode uncoated portion 111, which is a region at where the first active material is not applied. The first electrode uncoated portion 111 provides a passage for current flow between the first electrode plate and the outside.

The first electrode uncoated portions 111 are formed (or arranged) to overlap at the same position (e.g., to overlap each other) when the first electrode plates are stacked to form a multi-tab structure. The first electrode uncoated portion 111 is formed to protrude toward one side (e.g., one end) of the electrode assembly 110, and in some embodiments, a plurality of uncoated portions 111 may be welded to each other to form one first current collecting tab. The first electrode uncoated portion 111 is aligned at the first side of the electrode assembly 110 and protrudes therefrom.

The second electrode plate is formed by coating a second electrode active material, such as graphite or carbon, on a first electrode current collector formed of a metal foil, such as copper or nickel. The second electrode plate has a second electrode uncoated portion 112, which is a region at where the second active material is not applied.

The second electrode uncoated portions 112 are formed (or arranged) to overlap at the same position when the second electrode plates are stacked to form a multi-tab structure. The second electrode uncoated portion 112 is formed to protrude to the other side (e.g., an opposite side or end) of the electrode assembly 110, and in some embodiments, a plurality of the second electrode uncoated portions 112 may be welded to each other to form one second current collecting tab.

The separator is positioned between the first electrode plate and the second electrode plate (e.g., between each adjacent pair of first and second electrode plates) to prevent a short circuit and enable movement of lithium ions therebetween. The separator may be made of polyethylene, polypropylene, or a composite film of polyethylene and polypropylene. The present disclosure is not, however, limited by the material of the separator.

After the plurality of electrode plates are stacked, the electrode assembly 110 may be maintained in (e.g., fixed in) a stacked state by a separate insulating tape 113 attached to a region (e.g., a partial region) thereof. In some embodiments, the insulating tape 113 maintains the shape of the electrode assembly 110 so that the current collector plates 120 and 130 can be welded to the electrode assembly 110 at a correct position, and the structure of the electrode assembly 110 may be maintained within the final secondary battery structure.

The electrode assembly 110 is substantially accommodated in the case 150 together with the electrolyte. The electrolyte may be formed of a lithium salt, such as LiPF₆ or LiBF₄, in an organic solvent, such as ethylene carbonate (EC), propylene carbonate (PC), diethyl carbonate (DEC), ethyl methyl carbonate (EMC), or dimethyl carbonate (DMC). The electrolyte may be in the form of a liquid, a solid, or a gel.

The current collector plates 120 and 130 include a first current collector plate 120 electrically connected to the first electrode uncoated portion 111 and a second current collector plate 130 electrically connected to the second electrode uncoated portion 112.

The first current collector plate 120 is formed of a conductive material, such as aluminum, and is coupled to the first electrode uncoated portion 111 that protrudes from one end of the electrode assembly 110 and, thus, can be electrically connected to the first electrode plate(s).

In some embodiments, the first current collector plate 120 may include an electrode connection part (or portion) 121 and a terminal connection part (or portion) 125. In some embodiments, the electrode connection part 121 and the terminal connection part 125 may be coupled to each other through welding. In other embodiments, the electrode connection part 121 and the terminal connection part 125 may be integrally formed and bent.

The electrode connection part 121 may be formed in (e.g., may extend primarily in) the vertical direction along one side surface of the electrode assembly 110. The electrode connection part 121 may be coupled to (e.g., may be welded while in contact with) the first electrode uncoated portion 111 of the electrode assembly 110 and, thus, may have the same polarity (e.g., the first polarity) as the first electrode uncoated portion 111 and the first electrode plate.

The electrode connection part 121 may have a first piece (e.g., a first portion or first part) 122 and a second piece (e.g., a second portion or second part) 123 (see, e.g., FIGS. 4A and 4B).

The first piece 122 of the electrode connection part 121, which is a portion in direct contact with the first electrode uncoated portion 111, may have a first region 122a located at the upper edge thereof and welded to the terminal connection part 125, a second region 122b extending from the first region 122a and contacting the first electrode uncoated portion 111, and a third region 122c extending from the second region 122b and corresponding to the insulating tape 113 of the electrode assembly 110. In some embodiments, the first piece 122 may be configured such that the first region 122a and the second region 122b are symmetrical with each other with respect to the third region 122c in the longitudinal direction. For example, the third region 122c may be located approximately at the center of the first piece 122, and the second region 122b and the first region 122a may be sequentially connected to each of upper and lower portions of the third region 122c, respectively. Through this configuration, the first regions 122a are positioned at both edges (e.g., opposite edges) of the first piece 122, and the first region 122a positioned at (or extending from) the upper edge may be coupled to the terminal connection part 125 by welding.

The second piece 123 may have a shape that substantially corresponds to that of the first piece 122 and may be coupled to the first piece 122 by, for example, welding. The second piece 123 may similarity include a first region 123a welded to the terminal connection part 125, a second region 123b extending from the first region 123a, and a third region 123d extending from the second region 123b and corresponding to the insulating tape 113 of the electrode assembly 110. In addition, the second piece 123 may be configured such that the first region 123a and the second region 123b are symmetrical with each other with respect to the third region 123d in the longitudinal direction. For example, the third region 123d may be located approximately at the center of the second piece 123, and the second regions 123b and the first regions 123a may be sequentially connected to upper and lower portions of the third region 123d, respectively. The second region 123b may be connected to the first region 123a while forming an inclination angle (e.g., a predetermined inclination angle) with respect thereto and may be further depressed toward the electrode assembly 110. Through this structure, space for equipment to move when performing welding from the outside of the second piece 123 is provided, thereby allowing for accurate welding.

Welding holes (e.g., welding openings or slots) 123c may be formed in the second region 123b of the second piece 123. A plurality of welding holes 123c may be provided and arranged along (e.g., arranged adjacent to each other in) the longitudinal direction of the second piece 123, and each welding hole 120c may extend in the horizontal direction perpendicular to the longitudinal direction. Accordingly, the welding holes 123c formed in the second region 123b may extend in a direction substantially perpendicular to the first electrode uncoated portions 111 of the electrode assembly 110.

A portion of the second region 122b of the first piece 122 located inside the second piece 123 (e.g., located between the second piece 123 and the electrode assembly 110) may be exposed by (or through) the welding holes 123c in the second piece 123. Accordingly, when welding beams are irradiated from the outside, the welding beams pass through the welding holes 123c to reach the second region 122b of the first piece 122 to also weld the second region 122b to the first electrode uncoated portion 111 contact with the second region 122b.

The sum of the thicknesses of the first piece 122 and the second piece 123 may be in a range of about 0.6 mm to about 0.9 mm, and the thickness of the first piece 122 may be in a range of about 0.3 mm to about 0.5 mm. When the sum of the thicknesses of the first piece 122 and the second piece 123 is greater than or equal to about 0.6 mm, heat generated in the electrode assembly 110 may be easily dissipated, and when the sum of the thicknesses is less than or equal to about 0.9 mm, the capacity of the electrode assembly may not be limited or substantially limited. When the thickness of the first piece 122 is greater than or equal to about 0.3 mm, stability may be increased by preventing welding beams from penetrating into the electrode assembly 110 during welding, and when the thickness thereof is less than or equal to about 0.5 mm, the welding strength for the electrode assembly 110 can be secured.

According to these example configurations of the first piece 122 and the second piece 123, the entire thickness of the electrode connection part 121 can sufficient to attain rigidity, and only the first piece 122 exists in an area overlapping the second piece 123 at where the welding holes 123c are present for welding so that welding beams can easily reach the first electrode uncoated portion 111, thereby improving welding quality.

The terminal connection part 125 is positioned on the electrode assembly 110 and is formed in (e.g., extends primarily in) parallel to the cap plate 161, to be described later. For example, the terminal connection part 125 is positioned between the electrode assembly 110 and the cap plate 161 and has a substantially flat plate shape. The terminal connection part 125 may have a terminal hole (e.g., a terminal opening), and the first terminal 164 may be fastened to the terminal connection part 125 at (or through) the terminal hole by, for example, riveting. The terminal connection part 125 may be coupled to the electrode connection part 121 by welding. For example, the first region 122a of the first piece 122 and the first region 123a of the second piece 123, together forming the electrode connection part 121, are welded to the terminal connection part 125, and thus, the electrode connection part 121 and the terminal connection part 125 may form one single first current collector plate 120.

The second current collector plate 130 is made of a conductive material, such as nickel, and contacts the second electrode uncoated portion 112 protruding from the other end of the electrode assembly 110 and, thus, can be electrically connected to the second electrode plate. The second current collector plate 130 includes an electrode connection part 131 and a terminal connection part 135. However, because the configuration of the second current collector plate 130 is the same or substantially the same as that of the first current collector plate 120, a duplicate description thereof will be omitted.

The case 150 is made of a conductive metal, such as aluminum, an aluminum alloy, or nickel-plated steel, and has a substantially hexahedral shape with an opening through which the electrode assembly 110 can be inserted and seated. A cap plate 161 is coupled in the opening of the case 150 to seal the case 150. The internal surface of the case 150 is insulated to prevent an electrical short circuit from occurring therein. In some embodiments, one electrode of the electrode assembly 110 may be electrically connected to the case 150 through the cap plate 161. In such an embodiment, an electrical short circuit inside the case 150 can be prevented by the internal insulation treatment. In such an embodiment, the case 150 may act as a first electrode (e.g., a positive electrode).

The cap assembly 160 is coupled to an upper portion (opening) of the case 150. The cap assembly 160 includes a cap plate 161, an electrolyte injection hole (e.g., an electrolyte injection opening) 162, a stability vent 163, a first terminal 164, a second terminal 165, a gasket 166, a first terminal plate 167, a second terminal plate 168, a fastening plate 169, and a lower insulating member 170.

The cap plate 161 seals the opening in the case 150 and may be formed of the same material as the case 150. For example, the cap plate 161 may be coupled to the case 150 by laser welding. In addition, the cap plate 161 may be electrically independent or, in other embodiments, may be electrically connected to either the first current collector plate 120 or the second current collector plate 130.

The electrolyte injection hole 162 for injecting an electrolyte is formed in the cap plate 161. An electrolyte is injected into the case 150 through the electrolyte injection hole 162, and then, the electrolyte injection hole 162 is sealed by a stopper 162a.

The stability vent 163 has a relatively small thickness compared to other regions (e.g., other regions of the cap plate 161) and is formed at approximately the center of the cap plate 161. When the internal pressure in the case 150 reaches or exceeds a rupture pressure (e.g., a set rupture pressure), the stability vent 163 ruptures (or bursts) to prevent the secondary battery 100 from exploding.

The first terminal 164 and the second terminal 165 are respectively formed to pass through the cap plate 161. The first terminal 164 is coupled at a terminal hole formed in the terminal connection part 125 of the first current collector plate 120 to be electrically connected to the first current collector plate 120. Similarly, the second terminal 165 is coupled at the terminal hole formed in the terminal connection part 135 of the second current collector plate 130 to be electrically connected to the second current collector plate 130.

The gasket 166 is formed between the first and second terminals 164 and 165 and the cap plate 161. The gasket 166 is formed to surround the outside of (e.g., a periphery of) each of the first and second terminals 164 and 165 and is made of an insulating material. The gasket 166 seals an area between each of the first and second terminals 164 and 165 and the cap plate 161. The gasket 166 prevents external moisture from penetrating into the secondary battery 100 and prevents the electrolyte contained in the secondary battery 100 from leaking to the outside.

The first terminal plate 167 is coupled to the first terminal 164 protruding to the upper portion of (e.g., protruding above) the cap plate 161. After the first terminal plate 167 is coupled to the first terminal 164, the upper portion of the first terminal 164 may be riveted or the interface between the first terminal plate 167 and the first terminal 164 may be welded to fix the first terminal plate 167 to the first terminal 164.

The second terminal plate 168 is coupled to the second terminal 165 protruding to the upper portion of (e.g., protruding above) the cap plate 161. After the second terminal plate 168 is coupled to the second terminal 165, the upper portion of the second terminal 165 may be riveted or the interface between the second terminal plate 168 and the second terminal 165 may be welded to fix the second terminal plate 168 to the second terminal 165.

The fastening plate 169 is formed (or installed) between the cap plate 161 and the first terminal plate 167 and between the cap plate 161 and the second terminal plate 168. The fastening plate 169 may be formed of either an electrically conductive material or an insulating material. For example, the fastening plate 169 positioned under the first terminal plate 167 may be made of a conductive material, and the fastening plate 169 positioned under the second terminal plate 168 may be made of an insulating material. In such an embodiment, the first terminal 164 has the same polarity as the cap plate 161. When the fastening plate 169 is (e.g., when both fastening plates 169 are) made of an insulating material, the first terminal 164 and the second terminal 165 may be electrically separated (or electrically isolated) from the cap plate 161.

The lower insulating member 170 is formed between the first current collector plate 120 and the cap plate 161 and between the second current collector plate 130 and the cap plate 161 so that the first and second current collector plates 120, 130 and the cap plate 161 are electrically insulated.

Hereinafter, a configuration of a secondary battery according to another embodiment of the present disclosure will be described.

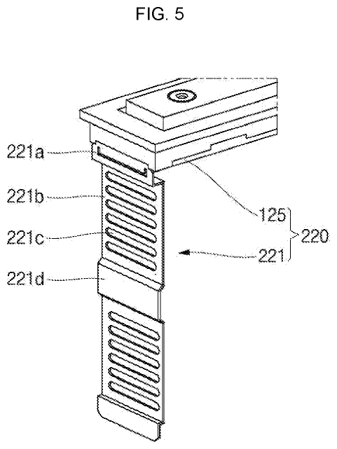

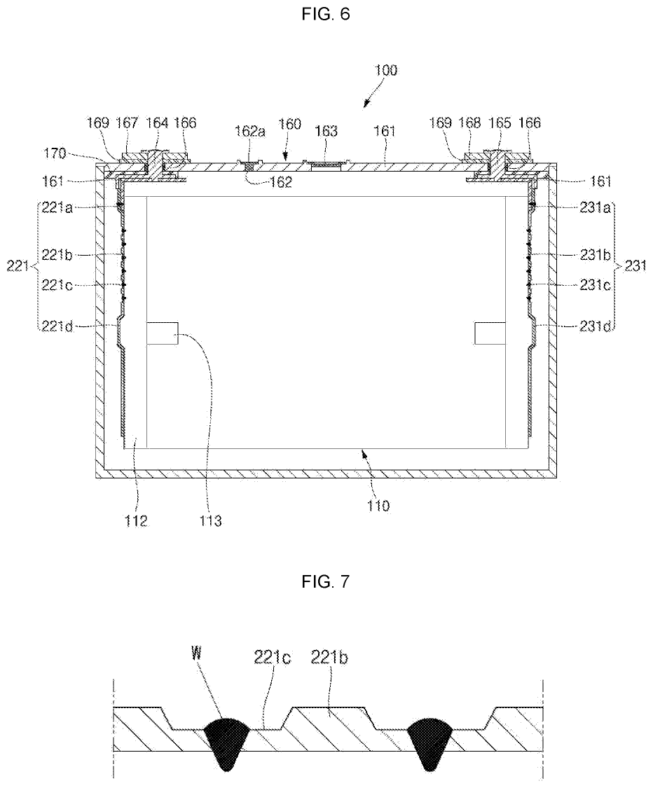

FIG. 5 is a perspective view of a current collector plate in a secondary battery according to another embodiment of the present disclosure. FIG. 6 is a cross-sectional view of a current collector plate and an electrode assembly that are coupled to each other in a secondary battery according to another embodiment of the present disclosure. FIG. 7 is a partial cross-sectional view of the current collector plate shown in FIG. 6.

The secondary battery according to present embodiment of the present disclosure may similarly include the electrode assembly 110, the case 150, and the cap assembly 160 similar to the previously-described embodiment. However, the configuration of a first current collector plate 220 and an element corresponding to a second current collector plate may differ from those of the previously described embodiment, and the following description will focus on these differences therebetween.

The first current collector plate 220 may have an electrode connection part 221 and a terminal connection part 125. The electrode connection part 221 may be configured as a single piece, different from the previous embodiment. The electrode connection part 221 may have a first region 221a, a second region 221b, and a third region 221d. The second region 221b may be further depressed in a direction toward the electrode assembly 110 while forming an inclination angle (e.g., a predetermined inclination angle) from the first region 221a, similar to the previous embodiment. Accordingly, accurate welding can be achieved by securing a working space for the welding equipment.

The second region 221b may include a groove 221c formed at a position to be welded. The thickness of the second region 221b at where the groove 221c is formed is reduced compared to the thickness of other areas of the second region 221b. The thickness of the second region 221b may be in a range of about 0.6 mm to about 0.9 mm, and a region of the second region 221b at where the groove 221c is formed may have a thickness in a range of about 0.3 mm to about 0.5 mm. When the thickness of the second region 221b is greater than or equal to about 0.6 mm, heat generated by the electrode assembly 110 may be easily dissipated, and when the thickness thereof is less than or equal to about 0.9 mm, the capacity of the electrode assembly may not be limited or substantially limited. When the thickness of the region of the second region 221b at where the groove 221c is formed is greater than or equal to about 0.3 mm, i welding beams may not penetrate into the electrode assembly 110 during welding, thereby increasing stability. When the thickness of the region of the second region 221b at where the groove 221c is formed is less than or equal to about 0.5 mm, the welding strength for the electrode assembly 110 can be secured.

As described above, in the secondary battery according to another embodiment of the present disclosure, when the first current collector plate 220 is formed as a single piece, the entire thickness of the electrode connection part 221 can be secured, and thus, the rigidity and heat generation performance of the electrode connection part 221 can be attained, similar to the previous embodiment. In addition, in the region where welding is to be performed, the thickness of the electrode connection part 221 may be reduced due to the groove 221c to allow welding beams to easily reach the first electrode uncoated portion 111, thereby improving welding quality. Similarly, a second current collector plate 230 may have an electrode connection part 231 configured in the same manner as the electrode connection part 221.

According to embodiments of the present disclosure, the entire thickness of an electrode connection part of a current collector plate can be provided to ensure rigidity and heat generating performance, while the thickness of the current collector plate is reduced only in the area necessary for welding so that welding beams can easily reach an electrode uncoated portion, thereby improving welding quality.

The foregoing embodiments are only some embodiments for embodying the aspects and features of the present disclosure, which is not limited to the embodiments described herein. It will be understood by a person skilled in the art that various changes in form and details may be made therein without departing from the spirit and scope of the present disclosure as defined by the following claims and their equivalents.

What is claimed is:

1. A secondary battery comprising:
a case having an accommodating space therein;
an electrode assembly in the case and having an uncoated portion at one end thereof;
a current collector plate electrically connected to the uncoated portion of the electrode assembly, a region of the current collector plate welded to the uncoated portion having a smaller thickness than other regions of the current collector plate where the current collector plate contacts the uncoated portion; and
a cap assembly sealing the case.

2. The secondary battery of claim 1, wherein the current collector plate is welded to the uncoated portion at a plurality of regions arranged adjacent to each other in a longitudinal direction of the uncoated portion, the regions extending in a direction perpendicular to the longitudinal direction.

3. The secondary battery of claim 1, wherein the current collector plate has a groove in the region welded to the uncoated portion.

4. The secondary battery of claim 1, wherein the current collector plate includes a first piece in contact with the electrode assembly and a second piece shaped to correspond to the first piece, and
wherein the second piece has a welding hole in the region welded to the uncoated portion.

5. The secondary battery of claim 4, wherein in the first piece, an area corresponding to the welding hole in the second piece is configured to be exposed to a welding beam.

6. The secondary battery of claim 1, wherein the current collector plate includes an electrode connection part welded to the uncoated portion of the electrode assembly and a terminal connection part having one end coupled to the electrode connection part and another end coupled to the cap assembly.

7. The secondary battery of claim 6, wherein, a region of the current collector plate that is welded to the uncoated portion is further recessed inwardly compared to the electrode connection part that is coupled to the terminal connection part.

8. The secondary battery of claim 6, wherein an inclination angle is formed between the region where the electrode connection part is coupled to the terminal connection part and a region where the current collector plate contacts the uncoated portion.

9. The secondary battery of claim 1, wherein a thickness of the region where the current collector plate is welded to the uncoated portion is in a range of 0.3 mm to 0.5 mm.

10. The secondary battery of claim 1, wherein a thickness of another region of the current collector plate in contact with the uncoated portion is in a range of 0.6 mm to 0.9 mm.
